(19) United States
(12) Patent Application Publication
(10) Pub. No.: US 2001/0036811 A1
(43) Pub. Date: Nov. 1, 2001

(54) Narrow band AM front end

(76) Inventors: Kaveh Kianush, Eindhoven (NL); Oswald Josef Moonen, Eindhoven (NL); Jan Geert Prummel, Eindhoven (NL)

Correspondence Address: Michael E. Marion, U.S. Philips Corporation, 580 White Plains Road, Tarrytown, NY, 10591, US

(21) Appl. No.: 09/822,473

(22) Filed: Mar. 30, 2001

(30) Foreign Application Priority Data
Mar. 31, 2000 (EP) 00201157.5

(51) Int. Cl. H04B 5/00

(52) U.S. Cl. 455/41; 455/325

(57) ABSTRACT

Receivers for receiving AM signals normally use many elements which are not integrable. This results in high costs and bulky circuits.

Proposed is to use switched capacitors in the RF stage of such a receiver, which results in reducing the external elements to a great extend.

The invention relates to a receiver as described in the preamble of claim 1.

The invention further relates to a RF stage for use in such a receiver.

A conventional (super-heterodyne) receiver uses a narrow-band LC filter circuit to provide RF selectivity and image rejection. The quality factor of this circuit is usually high to generate a large input signal and therefore facilitate good receiver sensitivity as well as image rejection. This RF filter must track the oscillator frequency to remain on the required channel. For digital tuning, the variable capacitance in the filter is realized by varactor diodes.

The performance of the conventional narrow-band input is very good, but the cost is relatively high. The varactor diodes are required for both the RF input filter and the VCO circuit. These diodes will have to be matched to allow good tracking of the filter with the oscillator across the frequency band. These two-matched varactor diodes make the application quite expensive.

This is particularly true for the AM receiver. Here, the absolute frequency values are quite low: 500 kHz to 1.7 MHz in the MW band and the required tuning range are very large. Therefore, the varactor diodes for this application are quite large and expensive.

Another extra complication with the varactor diode application is the required tuning voltage range to achieve the capacitance variation. In the low-voltage portable applications, this means an additional DC/DC converter just for the tuning voltage.

To avoid the above problems, many new receiver concepts are moving towards architectures with a wide-band input stage. For example, the applicant's integrated circuit TEA6840, utilizes a frequency conversion to a high IF value of 10.7 MHz for the AM path. The image frequency is therefore far outside the reception band and can be easily filtered off by a fixed wide-band filter.

The drawback of this solution is a reduced sensitivity. The very low quality factor, Q=1, of the filter means that a very small signal is available at the receiver input stage. A good Signal-to-Noise Ratio (SNR) can only be achieved by a very low noise figure of the receiver. This costs much power dissipation, which is not acceptable for portable applications. Even in the car radio applications, where the power consumption is less limiting, sensitivity figures are often 3 to 6 dB below the conventional narrow-band solutions.

The tracking issue is another unsolved problem. For example, there are various solutions for the VCO realization. In the portable application, where the channel selectivity requirements are not so stringent, fully integrated RC oscillators can meet the Carrier-to-Noise Ratio (CNR) requirement with acceptable power dissipation. Such oscillators can cover the AM tuning range without any varactor diodes and at a low tuning voltage. Unfortunately, however, it is not practical to combine the integrated oscillator with the conventional tuned RF circuit. The tuning behavior of the varactor diode is very different to the VCO, which deteriorates the tracking of the two circuits.

It is inter alia an object of the invention to provide a receiver and a RF stage with a good selectivity and sensitivity of the narrow-band solution, but without the expensive external varactor diodes. Furthermore, it is intended to achieve the filter tuning at low voltages.

To achieve this object a receiver according to the invention comprises the features of claim 1.

In this way both the selectivity and the tracking are improved. By using switched capacitors the use of varactors can be avoided. Further switched capacitors make it possible to use a lower voltage. So no DC/DC converter is necessary.

Embodiments of the receiver according to the invention are described in the dependent claims.

These and other aspects of the invention will be apparent from and elucidated with reference to the embodiments described hereinafter. Herein shows:

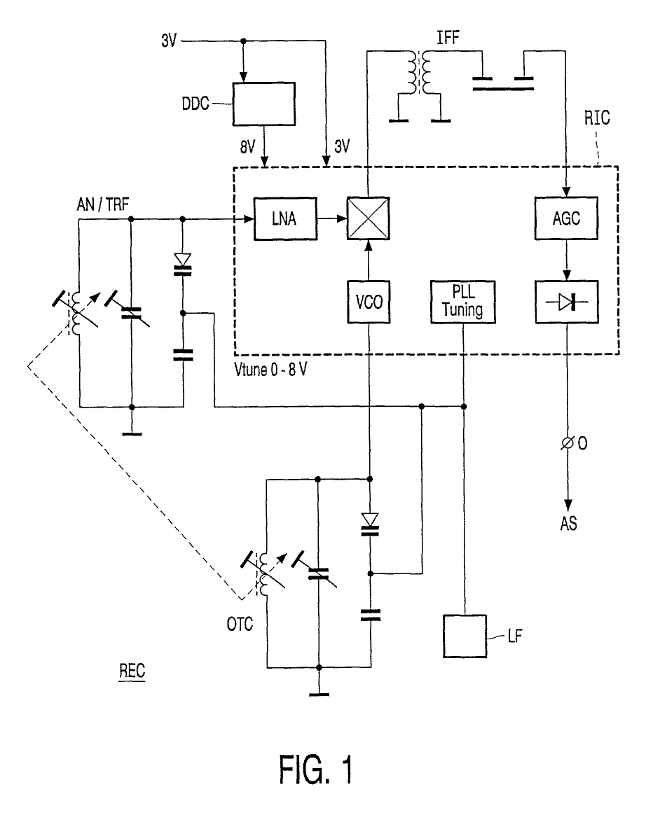

FIG. 1, an example of a prior art AM receiver,

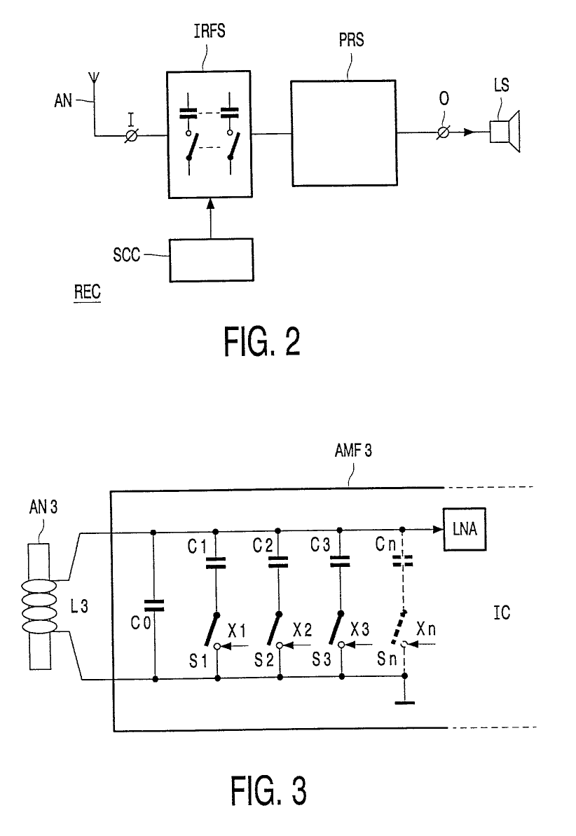

FIG. 2, an example of a receiver according to the invention,

FIG. 3, an example of a front end according to the invention.

FIG. 1 shows simplified system architecture and application diagram of a prior art AM receiver for the portable/personal market. A conventional AM radio receiver is based on the so called Super Heterodyne Architecture with an IF of around 450 kHz. Numerous external components are still required for the RF and IF processing. These external components are a real nuisance for the set maker. They are bulky, due to the low frequency nature of AM, require large printed circuit board area and need mechanical alignment of the RF and VCO stages. This alignment procedure is relatively complex, since a good frequency tracking is required. Furthermore, for a low-voltage portable application, a DC/DC converter is required to produce the required tuning voltage for the Varactor diodes. An extra complication with the converter is the interference caused by radiation into the RF and IF circuitry. In practice, the costs of the external parts are much larger than the actual AM radio IC.

This prior art receiver comprises an antenna/tuned RF stage AN/TRF coupled to the conventional receiver integrated circuit RIC. The receiver further comprises an oscillator tank circuit OTC and a loop filter LF. Further as described above this receiver needs a DC/DC converter DDC. Further the receiver comprises an IF filter coupled to the integrated circuit RIC. An output O of the receiver supplies an audio signal AS.

FIG. 2 shows a block schematic example of a receiver REC2 according to the invention having an integrated RF stage IRFS. At an input I, the receiver receives an antenna signal from an antenna AN. This input is coupled to the integrated RF stage IRFS which comprises switched capacitors. The integrated RF stage IRFS receives a control signal from a switch control circuit SCC for controlling the switching of the switches.

The output of the integrated RF stage is coupled to the processing stage PRS of the receiver, which supplies at an output O of the receiver REC on audio output signal to loudspeaker(s).

FIG. 3 shows an AM Front-end AMF3 for use in a receiver according to the invention.

In the proposed system (receiver/RF stage), the issues of selectivity and tracking are tackled separately. It is assumed that the VCO, regardless of its realization topology and tuning behavior is locked to the wanted channel by a PLL/FLL tuning system. The problem is now the realization of the front-end selectivity such that it is aligned to channel that is defined by the VCO frequency position. Here, we assume that the antenna circuit AN3 is inductive. For example, it can be a coil on ferrite or impedance transformed. The required tuned capacitance is realized inside the receiver IC by a bank of integrated capacitors C0 . . . Cn and switches S1 . . . Sn as shown in this figure. The inductance L3 and the fixed capacitor Co define the highest resonance frequency.

In practice, this minimum capacitance value is a combination of the internal integrated capacitor and the parasitic capacitors of the IC package, etc. To tune the LC circuit to a lower frequency, other integrated capacitors (C1-Cn) must be switched in parallel to the fixed capacitor by closing one or more of the integrated switches (S1-Sn). The position of these switches, open or closed, are set by the control signals (X1-Xn). The LC tuned circuit voltage is sensed and amplified by the Low Noise Amplifier (LNA). The LNA circuit is designed for high input impedance so that the quality factor of the tuned circuit is not reduced.

The above switched-capacitor structure can be configured and dimensioned such that it meets the specific receiver requirements. The practical realization aspects of the circuit to meet these requirements can have consequences for the actual system topology. The most important of these design aspects are the number, size and weighting factor of the capacitors in the array. The minimum number of capacitors in the array depends on the required frequency step resolution, the quality factor of the resonant circuit, the allowed pass-band ripple over the AM reception band and the capacitor-switching algorithm.

For efficiency of wiring and total capacitor die area, it would seem advantageous to use the possibility of combining the capacitors, more than one switch closed at the same time. A binary-weighting factor, for example, would yield a theoretically simple solution. In this case, C2 is twice as large as C1, C3 is twice as large as C2 and so on. The control signals (X1-Xn) are very easy to derive, just binary weighted frequency values from the receiver communication bus. The unfortunate problem with this configuration is that the frequency steps will not be evenly spaced out; each frequency step is √2 times smaller than the previous frequency step. Increasing the step resolution to cover all required frequency values despite the shift in step size would require unrealistically high number of bits for the binary switches. Note that the maximum useful number of bits is limited by the relative matching of the capacitors on the integrated circuit. A 0.5% relative matching gives an equivalent step resolution of only 8 bits.

The remedy is to adjust the capacitor values away from the binary weighting such that the frequency steps become evenly spaced across the band. To maintain the die area efficiency, it is desirable to dimension the capacitors such that for each consecutive step a new capacitor is switched in parallel to the existing capacitors. The total die area of the capacitors remains low, but the actual number of the capacitors in the array is of course increased to the number of frequency steps. The binary coded bits from the bus must now be decoded at the switch driver stage. In a typical AM MW band, approximately 500 kHz to 1.6 MHz, we have about 110 channels. Therefore a 7 or 8 bit frequency step definition, which is realistic for the typical relative capacitor matching specifications, would be adequate for channel selection. The new radio receiver-tuning scenario is as follows. The required frequency is sent to the integrated receiver IC by a so-called bus. This frequency word is used by the PLL to tune the VCO to the correct frequency. A derivative of the same frequency words is sent to the front-end switched-capacitor network. This is then decoded to drive the capacitor array. The tuned circuit is then positioned, within the acceptable tolerance, at the correct channel. In this way, the tracking between the VCO and the front-end is guaranteed without the use of matched varactor diodes. The VCO and the RF tuned circuit have their own individual mechanisms for tuning to the correct frequency that are derived from the communication bus.

An extra advantage of the switched-capacitor array is that the RF tuning can be achieved at low voltages. The tuning voltage requirement is now determined by the on-off characteristics of the switch. In a MOS realization, the control voltage has to be large enough to turn on the gate. In modern processes with a thin gate oxide, this will be in the 1 to 2 Volt range. Therefore, a portable radio application can be realized without a DC/DC converter.

When applying the proposed topology to a real receiver design, we need to consider the system specifications and the relevant IC parameters. For example, as previously mentioned, the relative matching of components, in particular capacitors, that can be achieved in the IC sets the limit to the number of useful bits. This in turn determines the maximum frequency step resolution. In the MW example, 0.5% matching allows an 8-bit frequency word that sets the frequency step resolution to about 5 kHz. The maximum allowable ripple across the band then sets the maximum quality factor of the LC circuit, which determines the selectivity at the 5 kHz resolution-distance. Typically, a quality factor of about 100 can be realized with acceptable gain variation across the band. This quality factor is high enough to achieve good sensitivity and image rejection.

The next major design consideration is the component tolerances. The integrated capacitors have a good relative matching, but their absolute values can be tens of percent off the nominal value. The external coil will also have a certain tolerance, which together with the capacitance tolerances, gives a large frequency offset from the nominally defined channel positions. Adjusting the coil for the lowest frequency position realigns all the frequency channels across the band at once. This is a simple alignment procedure.

There are a number of solutions for realizing the switches. However, the most suitable device for the switching operation is a MOSFET. Therefore, the availability of the BiMOS technology for this AM front-end topology is desirable. These MOS switches, either NMOS or PMOS, have to be dimensioned such that their On-Resistance does not influence the noise figure of the front-end. Furthermore, the Off-Capacitance of these switches will have to be negligible when compared to the actual capacitance that they are switching. In practice, this is relatively easy to accomplish. The largest capacitor requires also the largest MOS switch for noise considerations. But it can also tolerate the larger parasitic Off-Capacitance. The rest of the capacitor-switch combinations will then be scaled down.

The above circuit arrangement has been worked out for an AM receiver realized in a BiMOS technology. However, the basic principle of switching weighted capacitors by bus to eliminate external varactor diodes and yet maintain RF selectivity can be applied to other receiver systems realized in any process technology.

1. Receiver comprising an RF stage for receiving an antenna signal from an inductive antenna, a processing stage for processing the output signals of the RF stage and an output for supplying an audio signal, characterized in that the RF stage comprises switched capacitors for tuning the RF stage to a requested frequency.

2. Receiver as claimed in claim 1, characterized in that the switched capacitors of the RF stage comprise at least two series arrangements of a capacitor and switching means parallel whereby the switches are coupled to switch control means.

3. RF stage for use in a receiver according to claim 1.
